(19) United States
(12) Patent Application Publication
(10) Pub. No.: US 2024/0376657 A1
(43) Pub. Date: Nov. 14, 2024

(54) DETERGENT SUPPLY APPARATUS OR WASHING MACHINE COMPRISING SAME

(71) Applicant: SAMSUNG ELECTRONICS CO., LTD., Suwon-si Gyeonggi-do (KR)

(72) Inventors: Kwangmin CHUN, Suwon-si (KR); Baekgyu KWON, Suwon-si (KR); Geonhui JO, Suwon-si (KR); Byeongwoo KIM, Suwon-si (KR); Doyun LEE, Suwon-si (KR)

(73) Assignee: SAMSUNG ELECTRONICS CO., LTD., Suwon-si Gyeonggi-do (KR)

(21) Appl. No.: 18/784,336

(22) Filed: Jul. 25, 2024

Related U.S. Application Data
(63) Continuation of application No. PCT/KR2023/000104, filed on Jan. 3, 2023.

(30) Foreign Application Priority Data
Feb. 25, 2022 (KR) 10-2022-0025531

(51) Int. Cl. D06F 39/02; D06F 23/02; F04B 13/00; F04B 49/16; F16K 15/14

(52) U.S. Cl. CPC D06F 39/022; D06F 23/02; F04B 13/00; F04B 49/16; F16K 15/14

(57) ABSTRACT

A washing machine including a cabinet, a drum forming a laundry room, and a detergent supply apparatus, to supply detergent to the laundry room, and including a detergent container forming a detergent receiving space and a detergent pump coupleable to and decouplable from the detergent container and configured to pump detergent accommodated in the detergent receiving space. The detergent pump comprises a pumping portion including a compression space having a volume controllable to be varied such that the detergent accommodated in the detergent receiving space is drawn into an inner side of the detergent pump or is discharged to an outer side of the detergent pump as the volume of the compression space is varied. The detergent pump comprises a detergent discharge flow path connectable to the compression space to allow the detergent discharged from the compression space to move to the outer side of the detergent pump.

### CROSS-REFERENCE TO RELATED APPLICATION

This application is a continuation application, under 35 U.S.C. § 111 (a), of international application No. PCT/KR2023/000104, filed Jan. 3, 2023, which claims priority under 35 U. S. C. § 119 to Korean Patent Application No. 10-2022-0025531, filed Feb. 25, 2022, the disclosures of which are incorporated herein by reference in their entireties.

### BACKGROUND

### Field

The disclosure relates to a washing machine, and more particularly, to a detergent supply apparatus provided to supply detergent to a laundry room of a washing machine and a washing machine comprising the same.

### Description of the Related Art

In general, washing machines are appliances that use the driving force of a drive motor to agitate laundry, water, and detergent placed in a tub together, thereby allowing the laundry to be washed by mutual friction.

A detergent supply apparatus is a device that allows the detergent to be uniformly mixed into the supplied water and to be supplied together during the process of supplying water into a tub of a washing machine. In the case where the detergent is liquid, such liquid detergent may be supplied directly into the tub.

The detergent supply apparatus may include a detergent container in which the detergent may be accommodated and a detergent pump for pumping the detergent accommodated in the detergent container. The detergent received in the detergent container may be sucked into an inner side of the detergent pump and discharged from an outer side of the detergent pump to be transported with water to a laundry room.

In this case, the detergent is often viscous. Viscous detergents may cause friction with the walls formed inside the detergent pump, which may lead to losses during the movement of the detergent. To reduce the losses caused by the movement of the detergent, a method of creating an internal space in the detergent pump is considered.

### SUMMARY

According to an embodiment of the disclosure, a washing machine includes a cabinet, a drum arrangeable on an inner side of the cabinet such that while the drum is arranged on the inner side of the cabinet, the drum forms a laundry room, and a detergent supply apparatus configured to supply detergent to the laundry room, and including a detergent container forming a detergent receiving space to accommodate the detergent to be supplied to the laundry room, and a detergent pump coupleable to and decouplable from the detergent container, configured to pump the detergent accommodated in the detergent receiving space toward the laundry room. The detergent pump comprises a pumping portion including a compression space having a volume that is controllable to be varied such that the detergent accommodated in the detergent receiving space is drawn into an inner side of the detergent pump or is discharged to an outer side of the detergent pump as the volume of the compression space is varied. The detergent pump comprises a detergent discharge flow path connectable to the compression space such that while the detergent discharge flow path is connected to the compression space detergent discharged from the compression space is moved to the outer side of the detergent pump, and wherein a volume of the detergent discharge flow path may be less than or equal to the maximum volume of the compression space.

The volume of the detergent discharge flow path may be less than or equal to a maximum volume change of the compression space.

The pumping portion may include a cylinder configured to form the compression space, and a piston moveable to be inserted into the cylinder and enabled to discharge the detergent accommodated in the compression space from the compression space, and wherein a cross-sectional area of the detergent discharge flow path may be smaller than the cross-sectional area of the compression space.

The detergent pump may include a first check valve module configured to open or close the detergent discharge flow path by the pumping portion on a side where the detergent moves inward, and a second check valve module configured to open or close the detergent discharge flow path by the pumping portion on a side where detergent moves outward, wherein the detergent discharge flow path may be a detergent space disposed between the first check valve module and the second check valve module, and a volume of the detergent space may be equal to or smaller than the volume of the compression space.

The detergent pump may include a front case and a rear case coupleable to a rear side of the front case, and the front case may include a front case body, a detergent intake portion extending from the front case body in a direction in which the detergent pump is coupleable with the detergent container and forming an intake space therein, and a detergent discharge portion extending forwardly from the front case body and forming a discharge space therein.

The washing machine may further include a shared flow path connecting the intake space and the compression space and configured to allow detergent to be movable when the detergent is moved from the intake space to an inner side of the compression space, and a connecting flow path connecting the shared flow path and the discharge space and configured to allow detergent to be movable through the shared flow path when the detergent is moved from the compression space to the discharge space.

The front case may include a front insertion tube extending rearwardly of the detergent intake portion and forming a front shared flow path connected to the intake space, and the rear case may include a rear insertion tube extending forwardly to be inserted into the front insertion tube and forming a rear shared flow path connected to the compression space.

The cross-sectional area of the shared flow passage may be smaller than the cross-sectional area of the compression space.

The diameter of the shared flow path may be smaller than the diameter of the compression space.

The front case may include a connecting partition connected to the front insertion tube and extending to form the connecting flow path, and the detergent pump may include a flow path sealing member configured to form the connecting flow path by sealing a rear side of the front insertion tube and the connecting partition.

The connecting partition may include a first partition connected to one side of a connection opening formed on one side of the front insertion tube, a second partition connected to the other side of the connection opening and formed to be spaced apart parallel to the first partition, and a partition connection connecting the first partition and the second partition in a rounded manner.

A spacing distance between the first partition and the second partition may be smaller than the diameter of the front insertion tube.

The flow path sealing member may include a first flow path sealing member formed in an annular shape to seal the rear side of the front insertion tube, and a second flow path sealing member sealing the connecting partition and having a width smaller than the diameter of the first flow path sealing member.

The first check valve module may include a check valve body including a head portion capable of opening or closing the intake space, and an elastic support portion extending from one end of the head portion and formed integrally with the head portion, the elastic support portion having a cross-sectional area smaller than the one end of the head portion, and an elastic member configured to elastically bias the check valve body in a direction toward the intake space.

The cylinder may be formed to extend vertically, and the piston may move up and down within the cylinder to vary the volume of the compression space.

According to an embodiment of the disclosure, a detergent supply apparatus includes a pumping portion including a cylinder forming an compression space capable of varying in volume to allow detergent to be drawn inwardly or discharged outwardly, and a piston movably within the cylinder, and a detergent discharge flow path connected to the compression space on an inner side and configured to allow the detergent discharged from the compression space to move to an outer side, wherein the area of a cross-section cut in a direction perpendicular to a direction in which the detergent discharge flow path extends is smaller than the area of a cross-section cut in a direction perpendicular to a direction in which the compression space extends.

A distance between the two points at the farthest distance when any two points are selected on the edge of the cross-section cut in the direction perpendicular to the direction in which the detergent discharge flow path extends may be smaller than the distance between the two points at the farthest distance when any two points are selected on the of the cross-section cut in the direction perpendicular to the direction in which the compression space extends.

The diameter of the detergent discharge flow path may be less than or equal to the diameter of the compression space.

According to an embodiment of the disclosure, a detergent supply apparatus includes a pumping portion forming an compression space capable of varying in volume to allow detergent to be drawn inwardly or discharged outwardly, and a detergent discharge flow path connected to the compression space on an inner side and configured to allow the detergent discharged from the compression space to move to an outer side, wherein a volume of the detergent discharge flow path may be less than or equal to the maximum volume of the compression space.

The volume of the detergent discharge flow path may be less than or equal to the maximum volume change of the compression space.

### BRIEF DESCRIPTION OF THE DRAWINGS

FIG. 1 is a perspective view illustrating a washing machine according to an embodiment of the present disclosure.

FIG. 2 is a cross-sectional view illustrating a cross-section of the washing machine of FIG. 1 according to an embodiment of the present disclosure.

FIG. 3 is a rear exploded view illustrating a detergent supply apparatus of FIG. 2 disassembled and viewed from the rear according to an embodiment of the present disclosure.

FIG. 4 is a perspective view illustrating a detergent pump of the detergent supply apparatus of FIG. 3 according to an embodiment of the present disclosure.

FIG. 5 is an exploded view illustrating the detergent pump of FIG. 4 disassembled according to an embodiment of the present disclosure.

FIG. 6 is an exploded view illustrating a front case and a flow path sealing member of FIG. 5 according to an embodiment of the present disclosure.

FIG. 7 is a cross-sectional perspective view illustrating the detergent pump of FIG. 4 cut along AA′ according to an embodiment of the present disclosure.

FIG. 8 is a cross-sectional perspective view illustrating a flow in which the detergent introduced into the detergent pump of FIG. 7 is discharged according to an embodiment of the present disclosure.

FIG. 9 is a cross-sectional view of the detergent pump of FIG. 4 cut along AA′ according to an embodiment of the present disclosure.

FIG. 10 is a cross-sectional view illustrating a flow of the detergent introduced into the detergent pump of FIG. 9 moving toward a connecting opening according to an embodiment of the present disclosure.

FIG. 11 is a cross-sectional view illustrating the detergent pump of FIG. 4 cut along BB′ according to an embodiment of the present disclosure.

FIG. 12 is a perspective cross-sectional view illustrating the detergent pump of FIG. 7 cut along CC′ according to an embodiment of the present disclosure.

FIG. 13 is a perspective cross-sectional view illustrating the detergent pump of FIG. 4 cut along DD′ according to an embodiment of the present disclosure.

FIG. 14 is a perspective cross-sectional view illustrating a flow in which the detergent introduced into the detergent pump of FIG. 13 is discharged through a detergent discharge portion according to an embodiment of the present disclosure.

FIG. 15 is a cutaway cross-sectional view illustrating the detergent supply apparatus of FIG. 3 according to an embodiment of the present disclosure.

FIG. 16 is a graph summarizing the results of experiments in which outflow amounts were compared after different liquids were introduced into the detergent pump of FIG. 4 according to an embodiment of the present disclosure.

FIG. 17 is a cross-sectional view illustrating a detergent pump according to an embodiment of the present disclosure.

FIG. 18 is a cross-sectional view illustrating a detergent pump according to an embodiment of the present disclosure.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, and the like are defined with reference to the drawings and are not intended to limit the shape and location of each component.

One aspect of the present disclosure provides a detergent supply apparatus capable of reducing losses during the movement of detergent in a detergent supply apparatus of a washing machine, and a washing machine comprising the same.

One aspect of the present disclosure provides a detergent supply apparatus capable of increasing the volumetric efficiency, which is a ratio of detergent drawn into the detergent supply apparatus to detergent discharged therefrom, and a washing machine comprising the same.

According to the spirit of the present disclosure, the detergent supply apparatus may reduce the friction between the detergent and the configurations forming flow paths by minimizing the flow paths through which the detergent passes, thereby reducing losses incurred during the movement of the detergent, and the washing machine comprising the same.

According to the spirit of the present disclosure, the detergent supply apparatus may form a smaller volume of the detergent discharge flow path through which the detergent is discharged compared to the maximum volume of the compression space, the volume of which varies to allow the detergent to be drawn in, thereby increasing the volumetric efficiency, and the washing machine comprising the same.

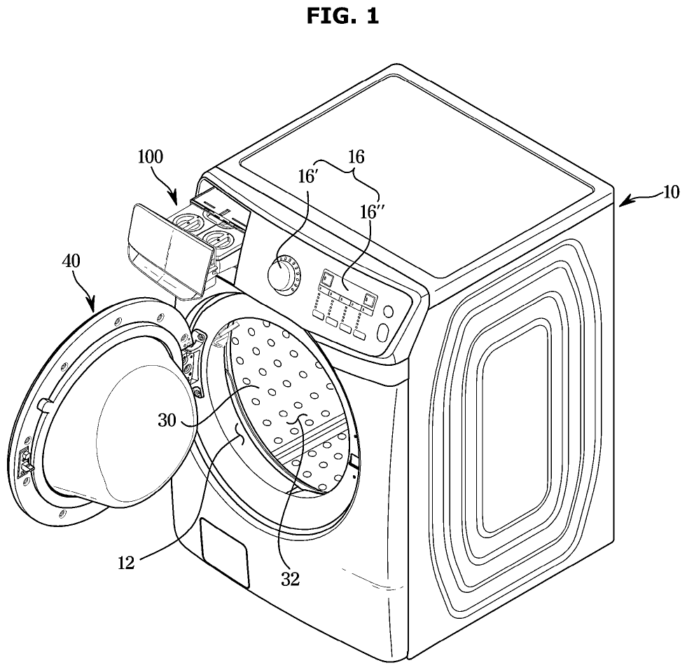

In particular, as shown in FIG. 1, a direction in which a detergent container 200 of a detergent supply apparatus 100 is removed may be defined as forward, and based on the direction, rear, left and right sides, and upper and lower may be defined.

Hereinafter, various embodiments of the present disclosure will be described in detail with reference to the accompanying drawings.

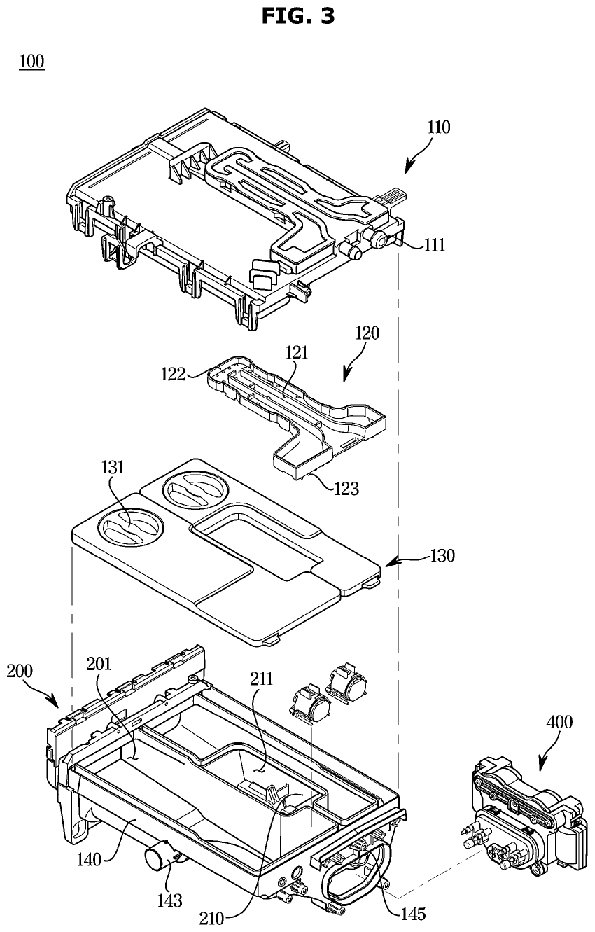

FIG. 1 is a perspective view illustrating a washing machine 1 according to an embodiment of the present disclosure. More particularly, FIG. 1 is a perspective view illustrating a door 40 of the washing machine 1 being opened at an opening 12 and the detergent container 200 (FIG. 3) being withdrawn.

The washing machine 1 may include a device that uses the driving force of a motor 61 to agitate together laundry, water, and detergent loaded inside a laundry room 32, thereby enabling the laundry to be washed by mutual friction. Here, the laundry may be clothing. When the laundry is clothing, the washing machine 1 may be referred to as a clothing treatment apparatus.

The washing machine 1 may be classified into a drum washing machine that washes the laundry by rotating a drum 30 to repeatedly lift and drop the laundry, and an electric washing machine that washes the laundry by using a water current generated by a pulsator when the drum 30 rotates.

The washing machine 1 may also be categorized according to a direction in which the laundry is loaded into the washing room 32. The washing machine 1 may be classified as a front-loading washing machine, in which the laundry is received into the washing room 32 from the front, and a top-down loading washing machine, in which the laundry is received into the washing room 32 from the top.

Although the washing machine 1 of FIG. 1 shows a drum-washing machine and is a front-loading washing machine as an example, but is not limited thereto. The ideas disclosed below may be applied to other types of the washing machine 1.

As shown in FIG. 1, the washing machine 1 may include a cabinet 10 that forms an exterior thereof and accommodates various components therein. The cabinet 10 may be formed in a substantially hexahedral shape.

The cabinet 10 may be provided with a control panel 16 on a front surface, the control panel 16 including an inputter 16′ that receives an operation command from a user and a display 16″ that displays operation information of the washing machine 1.

An opening may be formed in the front surface of the cabinet 10 to allow laundry to be loaded into the drum 30. The opening formed in the front surface of the cabinet 10 may be opened or closed by the door 40. The door 40 may be rotatably mounted on the front surface of the cabinet 10 by a hinge member (not shown).

The washing machine 1 may include the detergent supply apparatus 100. The detergent supply apparatus 100 may be a device that supplies detergent to the inside of a tub 20 of the washing machine 1. In FIG. 1, the detergent supply apparatus 100 may be shown to be arranged on an upper right side of the washing machine 1, but this is by way of an example only and is not limited thereto.

The further detailed configuration of the detergent supply apparatus 100 and the washing machine 1 including the same will be described further below.

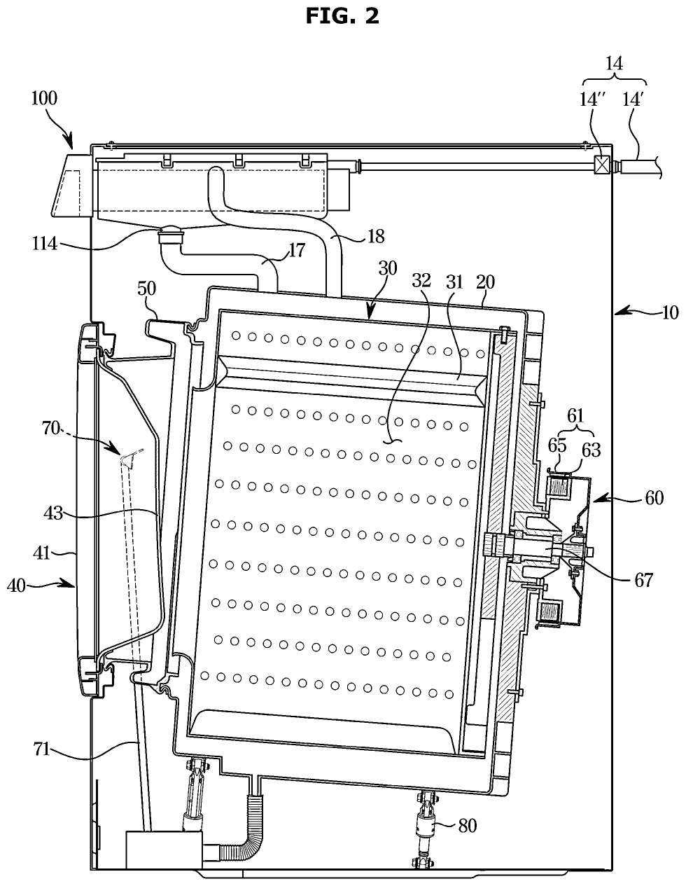

FIG. 2 is a cross-sectional view illustrating a cross-section of the washing machine 1 of FIG. 1.

As shown in FIG. 2, an inner side of the cabinet 10 forming the exterior of the washing machine 1 may include the tub 20 configured to receive a mixture of water and detergent. The drum 30 forming the laundry room 32 may be disposed inside the tub 20 to receive the laundry. In other words, it may be referred to as the drum 30 being disposed on the inner side of the cabinet 10 and the laundry room 32 being formed on the inner side of the drum 30.

The tub 20 and the drum 30 may have front openings to allow laundry to be put in or taken out from the front of the cabinet 10, and the front openings of the tub 20 and drum 30 may be positioned to correspond to the openings in the front of the cabinet 10.

The opening provided in the front of the cabinet 10 may be opened or closed by the door 40. The door 40 may include a door frame 41 and a door glass 43. The door glass 43 may be formed of a transparent tempered glass material to allow the inside of the cabinet 10 may be visible.

A water supply device 14 including a water supply pipe 14′ and a water supply valve 14″ for controlling the water supply may be provided on an upper portion of the tub 20. In addition, the detergent supply apparatus 100 may be installed on the front upper portion of the tub 20 to supply detergent to the inside of the tub 20 during a water supply process.

The detergent supply apparatus 100 may be connected to the tub 20 through a supply pipe 17. The water supplied through the water supply pipe 14′ may be mixed with detergent via the detergent supply apparatus 100, and the mixture of water and detergent may be supplied to the inside of the tub 20 through an opening 114 of the detergent supply apparatus 100. In the case where the detergent is a liquid detergent, the water supply pipe 14′ may supply water directly to the inside of the tub 20 via a separate control valve (not shown), and the liquid detergent may pass through the detergent supply apparatus 100 and be supplied to the inside of the tub 20 via a detergent supply pipe (not shown).

The detergent supply apparatus 100 may be connected to the tub 20 through an air pipe 18. The air pipe 18 may be configured to allow air to flow into and/or out of the detergent supply apparatus 100. Accordingly, the air pipe 18 may prevent the pressure in the detergent supply apparatus 100 from decreasing.

A rear side of the drum 30 may be provided with a drive portion 60. The drive portion may be a configuration for rotating the drum 30, and may be configured to transmit the driving force generated by the motor 61 to a rotation shaft 67 to rotate the drum 30.

The motor 61 may include a stationary stator 63 and a rotor 65 that rotates in electromagnetic interaction with the stator 63 to convert an electric power into a mechanical rotational force.

The tub 20 may store a mixture of water and detergent, and may be formed in a substantially cylindrical shape. The tub 20 may be secured to the inside of the cabinet 10. The opening formed in the front of the cabinet 10 and the tub 20 may be connected by a diaphragm 50.

A spray nozzle 70 may be provided on one side of the diaphragm 50, which is connected to a circulation hose 71 and sprays the circulating mixture of water and detergent into the inside of the drum 30. The spray nozzle 70 may be arranged to spray the mixture of water and detergent uniformly over the laundry accommodated in the drum 30. The circulation hose 71 may be connected to a circulation pump for pumping a mixed water (i.e., the mixture of water and detergent) stored in a lower portion of the tub 20.

The drum 30 may perform washing by rotating inside the tub 20 to lift and lower the laundry. A plurality of lifters 31 may be arranged inside the drum 30.

A drainage device (not shown) including a drain pipe (not shown) for draining water inside the tub 20, a drain valve (not shown), and the like may be installed at the lower portion of the tub 20.

The tub 20 may be configured to be elastically supported from the cabinet 10 by springs (not shown) at the top and dampers 80 at the bottom. In other words, the springs and the dampers 80 may be arranged to absorb vibration energy between the tub 20 and the cabinet 10 when vibrations generated by rotation of the drum 30 are transmitted to the tub 20 and the cabinet 10, thereby damping the vibrations.

A configuration of the detergent supply apparatus 100 will be described in more detail below.

FIG. 3 is a rear exploded view illustrating the detergent supply apparatus 100 of FIG. 2 disassembled and viewed from the rear.

As shown in FIG. 3, the detergent supply apparatus 100 may include a cover 110. The cover 110 may form an exterior of the detergent supply apparatus 100 together with a housing 140. The cover 110 may be coupled to an upper portion of a water supply plate 120 to enclose the water supply plate 120. In other words, the cover 110 may be coupled to the water supply plate 120 to form a flow path through which the water supplied from the water supply device 14 moves.

The cover 110 may include a washing water inlet (water inlet) 111 connected to the water supply device 14. Water may flow into the detergent supply apparatus 100 through the washing water inlet 111.

The detergent supply apparatus 100 may further include the water supply plate 120 coupled to the cover 110 so as to be positioned between the cover 110 and the housing 140. The water supply plate 120 may include guide partitions 121 that partition a flow path for water to flow through. The water supply plate 120 may form, together with the cover 110, a flow path through which the water supplied from the water supply device 14 may travel.

The water supply plate 120 may include washing water flow holes 122 configured to allow the water supplied from the water supply device 14 to a space between the cover 110 and the water supply plate 120 to be discharged into a water supply chamber 211. The washing water flow holes 122 may be formed through the water supply plate 120. The washing water flow holes 122 may be formed in a region of the water supply plate 120 to correspond to the water supply chamber 211. In other words, the washing water flow holes 122 may be formed in a portion of the water supply plate 120 facing the water supply chamber 211.

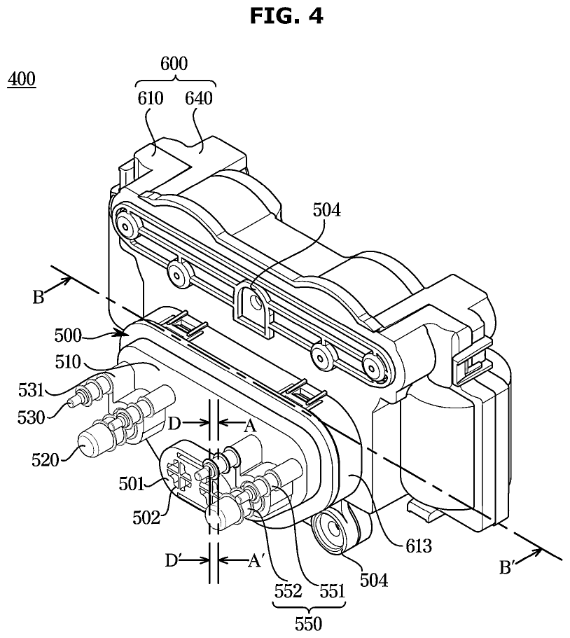

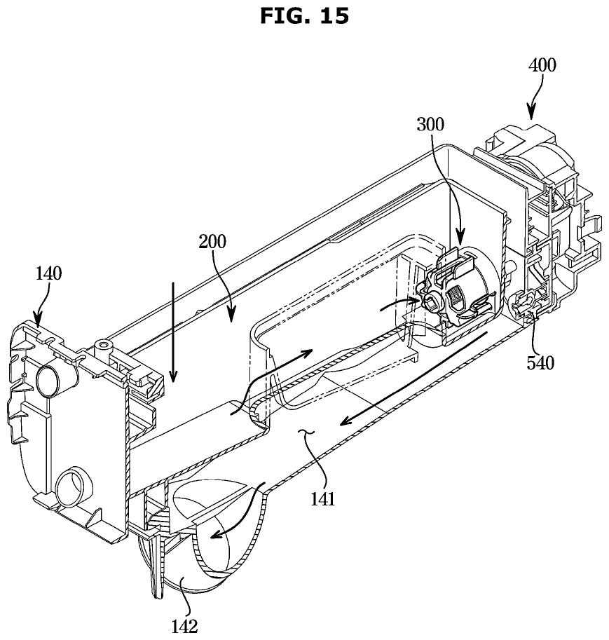

The water supply plate 120 may include though holes 123 through which a portion of the water supplied from the water supply device 14 may pass to prevent the detergent discharged into a mixing chamber 141 (see FIG. 15) by a detergent discharge portion 540 (see FIG. 4) of a detergent pump 400 from remaining in the mixing chamber 141. The through holes 123 may be located on an upstream side of the washing water flow holes 122 in a direction in which the water supplied from the water supply device 14 travels. In other words, the through holes 123 may be formed in the water supply plate 120 so as to be adjacent to the washing water inlet 111. A portion of the water supplied from the water supply device 14 may be discharged into the water supply chamber 211 via the washing water flow holes 122, while the remaining portion may be discharged into the mixing chamber 141 via the through holes 123.

The detergent supply apparatus 100 may further include cases 500 and 600 together with the cover 110 to form the exterior of the detergent supply apparatus 100. The cases 500 and 600 may be detachably coupled to the detergent container 200 to allow the detergent container 200 forming a detergent receiving space 201 for receiving the detergent therein to be withdrawn.

Referring to FIG. 15, an outlet 142 may be formed in a lower portion of the housing 140 to allow at least one of the water and the detergent to be discharged to the outside of the detergent supply apparatus 100. The outlet 142 may be connected to a connection pipe (see FIG. 2), and at least one of the water and the detergent discharged through the outlet 142 may be moved to the inside of the tub 20 through the connection pipe. The lower portion of the housing 140 may be inclined toward the outlet 142 such that at least one of the water and the detergent is smoothly discharged through the outlet 142 without accumulating in the lower portion of the housing 140.

The housing 140 may include an air portion 143 on one side that allows air to pass through and regulate the pressure in the housing 140.

The detergent supply apparatus 100 may include the detergent container 200 including the detergent receiving space 201 in which the detergent may be received.

Although the detergent container 200 is shown in FIG. 3 as being integrally formed, the detergent container 200 may include a detergent box (not shown) forming the detergent receiving space 201 in which the detergent may be received, and an inner housing (not shown) that may accommodate the detergent box.

The detergent container 200 may be movably mounted to the housing 140. The detergent container 200 may contain a liquid detergent. The liquid detergent may include rinses, fabric softeners, or the like.

A detergent container cover 130 may be provided on an upper side of the detergent container 200 to cover the detergent container 200. The detergent container cover 130 may be formed to correspond to the shape of the upper side of the detergent container 200. However, the detergent container cover 130 may not be formed at a position corresponding to the washing water flow holes 122 of the water supply plate 120 to allow the water to move.

A detergent container cap 131 may be provided on a front side of the detergent container cover 130 to allow detergent to be introduced into the detergent receiving space 201. The detergent container cap 131 may be detachably coupled to the detergent container cover 130.

The detergent supply apparatus 100 may further include the water supply chamber 211 formed in the detergent container 200 to allow the water passing through the washing water flow holes 122 to flow into the detergent container 200. The water supply chamber 211 may be defined by the water supply chamber frame 210 of the detergent container 200. The water passing through the washing water flow holes 122 may flow directly into the water supply chamber 211. The water supplied between the cover 110 and the water supply plate 120 may easily pass through the washing water flow holes 122 by gravity and flow into the water supply chamber 211.

In some cases, powdered detergent may be added to the water supply chamber 211. When powdered detergent is added to the water supply chamber 211, the powdered detergent may be introduced into the mixing chamber 141 together with the water introduced through the washing water flow holes 122. A communication hole (see FIG. 15) may be formed on a lower side of the water supply chamber 211. The water supply chamber 211 and the mixing chamber 141 may be arranged to be in communication with each other.

The detergent supply apparatus 100 may further include the mixing chamber 141 arranged to allow at least one of the water discharged from the water supply chamber 211 and the detergent discharged from the detergent container 200 to pass through and be supplied to the tub 20 (see FIG. 2). The mixing chamber 141 may be formed between the detergent container 200 and the housing 140.

The detergent supply apparatus 100 may include the detergent pump 400 arranged to draw detergent from the detergent container 200 and discharges the drawn detergent into the mixing chamber 141.

The detergent pump 400 will be described in more detail below.

FIG. 4 is a perspective view illustrating the detergent pump 400 of the detergent supply apparatus 100 of FIG. 3.

As shown in FIG. 4, the detergent pump 400 may include the cases 500 and 600 forming the exterior.

The cases 500 and 600 may include the front case 500 forming a front exterior and the rear case 600 coupled to a rear side of the front case 500. For ease of manufacture, the rear case 600 may include a middle case 610 that is coupled to the front case 500 at the rear side of the front case 500, and a case cover 640 is coupled to the middle case 610 at a rear side of the middle case 610.

The front case 500, the middle case 610, and the case cover 640 included in the cases 500 and 600 may be symmetrical on the left and right with respect to the detergent pump 400 as the center. In other words, since the detergent container cap 131 (see FIG. 3) for adding detergent to the detergent container 200 may be formed in a pair on the left and right, the cases 500 and 600 having corresponding configurations may be formed symmetrically on the left and right.

Furthermore, all the configurations described below may be formed symmetrically on the left and right with respect to to a central portion of the detergent pump 400.

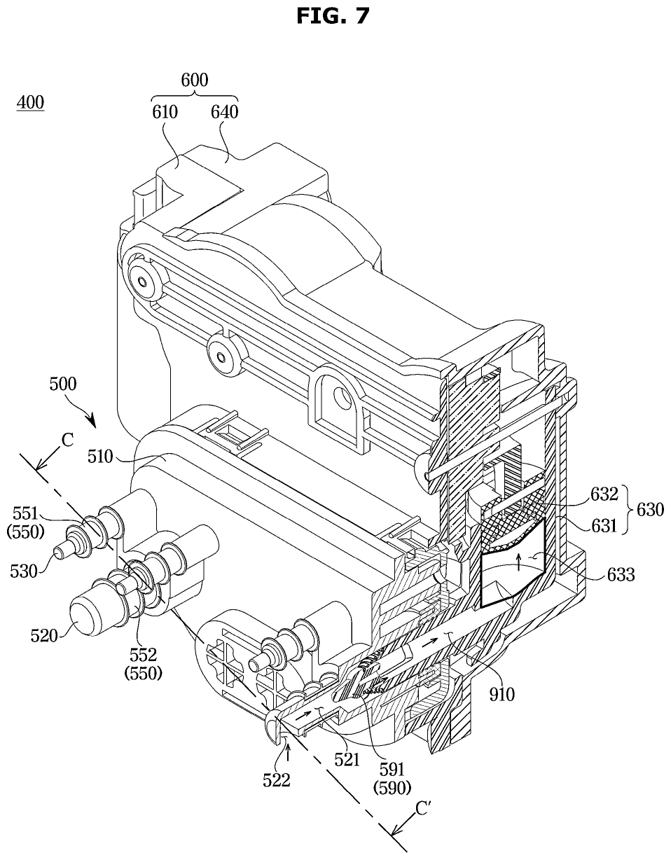

Referring to FIG. 7, in the case where the cases 500 and 600 are manufactured by an injection molding process, to facilitate their manufacture, the middle case 610 may include a middle outer case 611 provided on an outer side, and a middle inner case 612 provided on an inner side of the middle outer case 611 and corresponding to the rear side of the front case 500.

The front case 500 may include a front case body 510. The front case 500 may include a detergent intake portion 520 extending from the front case body 510 in a direction in which the detergent pump 400 is coupled to the detergent container 200, and forming an intake space 521 therein. In other words, the detergent intake portion 520 may extend forwardly, and the intake space 521 may be formed on an inner side of the detergent intake portion 520.

The front case 500 may include the detergent discharge portion 540 extending forwardly from the front case body 510 and forming a discharge space 541 therein. In other words, the detergent discharge portion 540 may extend forwardly, and the discharge space 541 may be formed on an inner side of the detergent discharge portion 540.

A detecting member 530 for measuring the amount of detergent remaining in the detergent receiving space 201 may be provided adjacent to the detergent intake portion 520. When the detergent pump 400 is coupled with the detergent container 200, the detecting member 530 may measure the amount of detergent by contacting the detergent within the detergent receiving space 201. Accordingly, the detecting member 530 may be inserted into the detergent receiving space 201.

The detecting member 530 may be shaped to extend forwardly. If the detecting member 530 has a curved shape, the probability of residual detergent remaining on the detecting member 530 may thereby be increased. Accordingly, it may be preferable for the detecting member 530 to be shaped to extend straight forwardly.

The detecting member 530 may include a pair of electrodes. The detergent may be an electrically conductive electrolyte, and thus current may flow between the pair of electrodes when the pair of electrodes is immersed in the detergent. As current flows between the pair of electrodes, the amount of detergent in the detergent receiving space 201 may be measured when it falls below a certain value.

To protect the detecting member 530, a detecting member case 531 may be provided that encloses the detecting member 530 and extends forwardly from the front case body 510. The detecting member 530 may extend further than the detecting member case 531 extends, and may be in contact with the detergent.

A hole sealing member 550 (551, 552) may be provided on a front side of the detergent intake portion 520 and the detecting member case 531 that encloses the detecting member 530, respectively. On a rear side of the detergent container 200, a plurality of detergent container holes 220 may be provided into which the detergent intake portion 520 and the detecting member case 531 may be inserted. The hole sealing member 550 may each be arranged to prevent the detergent from leaking between the plurality of detergent container holes 220 and the detergent intake portion 520 or the detecting member case 531.

The detecting member 530 may be inserted into a terminal receiving portion 602 included in the middle case 610. On an inner side of the terminal receiving portion 602, a terminal 604 may be positioned that contacts the detecting member 530 and supplies power to the detecting member 530.

The detecting member 530 may be configured to detect the remaining amount of detergent (or a level of detergent) within the detergent container 200 when current is generated by the electrically connected terminal 604. The detecting member 530 may be located within the detergent container 200.

The middle case 610 may have a case opening (not shown) formed to accommodate the front case 500. The case opening may be formed by a case opening frame 613 that is formed to surround the case opening and extends forwardly. The case opening may be provided in a shape corresponding to the shape of a rear edge of the front case 500. Accordingly, the case opening frame 613 may guide the front case 500 to be received into the case opening of the middle case 610.

The middle case 610 may include a support rib 504 provided on an upper side of the case opening frame 613 to increase strength.

The support rib 504 may be provided in a shape corresponding to a position corresponding to a support protrusion 145 (see FIG. 3) formed at the rear side of the housing 140. When an impact is applied to the detergent pump 400, the impact may be distributed by the support rib 504 and the support protrusion 145.

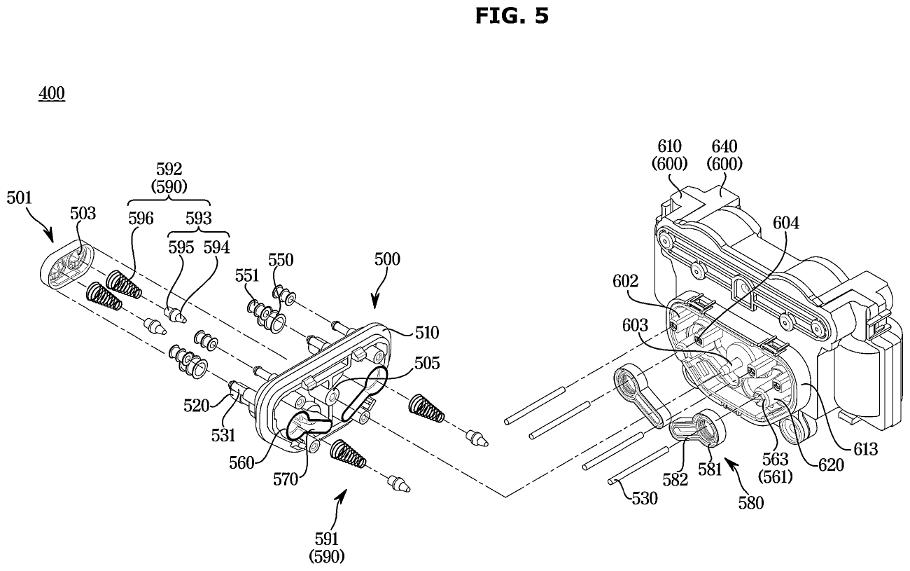

FIG. 5 is an exploded view illustrating the detergent pump 400 of FIG. 4 disassembled.

As shown in FIG. 5, a detergent discharge cap 501 may be provided on a front side of the detergent discharge portion 540 to protect the detergent discharge portion 540. A detergent outlet opening 502 (see FIG. 4) may be provided on a front side of the detergent outlet cap 501 to allow detergent to be discharged.

A check valve module 590 may be provided to open or close a flow path through which the detergent moves. The check valve module 590 may include a check valve body 593 provided to open or close the flow path through which the detergent moves, and an elastic member 596 provided to elastically bias the check valve body 593 to block the flow path through which the detergent moves. This will be described in more detail in the relevant sections.

The check valve module 590 may be formed adjacent to the detergent discharge portion 540. As the check valve module 590 may include the elastic member 596, the detergent discharge cap 501 may be provided with anti-separation ribs 503 at a position corresponding to the elastic member 596 such that the elastic member 596 may be supported. The detergent outlet opening 502 (see FIG. 4) may be formed between the anti-separation ribs 503 to allow the detergent to move.

In this time, the check valve module 590 on the detergent intake portion 520 side may be referred to as a first check valve module 591. The check valve module 590 on the detergent discharge portion 540 side may be referred to as a second check valve module 592. In other words, the check valve module 590 may include the first check valve module 591 configured to open or close a detergent discharge flow path 900 by a pumping portion 630 on a side where the detergent moves inward, and the second check valve module 592 configured to open or close the detergent discharge flow path 900 by the pumping portion 630 on a side where the detergent moves outward.

The front case 500 may include a front insertion tube 560 coupled to a rear side of the detergent intake portion 520 to extend rearwardly from the front case body 510, and forming a front shared flow path 911 therein. In other words, the front shared flow path 911 (see FIG. 7) may be formed within the front insertion tube 560.

The rear case 600 may include a rear insertion tube 620 extending forwardly to be inserted into an inner side of the front insertion tube 560, and forming a rear shared flow path 912 (see FIG. 7) therein. By inserting the rear insertion tube 620 into the front insertion tube 560, the front case 500 may be coupled to the middle case 610 without a separate coupling member. Additionally, it should be understood that a coupling member (not shown) may be provided to stably couple the front case 500 to the middle case 610. In this case, the structure in which the rear insertion tube 620 is inserted into the front insertion tube 560 may allow for fewer coupling members (not shown) to be used to stably couple the front case 500 to the middle case 610.

Although the present disclosure shows the rear insertion tube 620 being inserted into the inner side of the front insertion tube 560, but the spirit of the present disclosure may also be applied to a structure in which the front insertion tube 560 is inserted into an inner side of the rear insertion tube 620.

In this case, since the front insertion tube 560 and the rear insertion tube 620 may be formed symmetrically on the left and right with respect to the center of the detergent pump 400, the insertion of the front insertion tube 560 into the rear insertion tube 620 may allow the insertion positions of the front case 500 and the middle case 610 to be aligned.

The detecting member may be the pair of electrodes extending forwardly. The pair of electrodes may be provided symmetrically on the left and right with respect to the center of the detergent pump 400.

The middle case 610 may include a detection receiving portion extending forwardly to allow the detecting member to be inserted.

The middle case 610 may include a fixing member 603 protruding forwardly to guide the front case 500 to be coupled to the middle case 610. The front case 500 may include a fixing portion 505 provided at a position corresponding to the fixing member 603 to allow the fixing member 603 to be inserted.

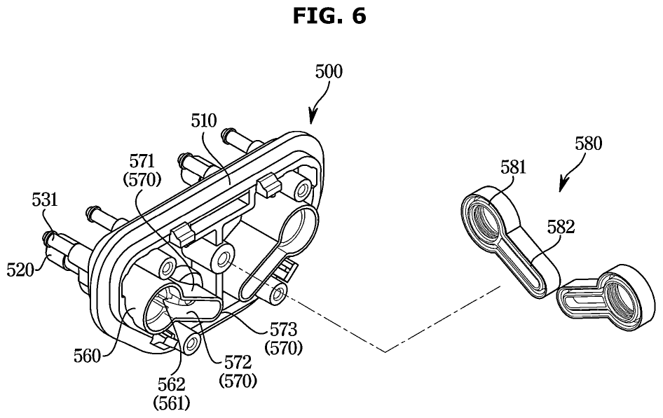

FIG. 6 is an exploded view illustrating the front case 500 and a flow path sealing member 580 of FIG. 5.

As shown in FIG. 6, the front case 500 may include a connecting partition 570 connected to the front insertion tube 560 and extending rearwardly so as to form a connecting flow path 920, which will be described later, through which detergent passes.

The front case 500 may include the flow path sealing member 580 configured to form the connecting flow path 920 by sealing rear sides of the front insertion tube 560 and the connecting partition 570.

A connection opening 561 communicating with an outer side of the front insertion tube 560 may be formed on one side of the front insertion tube 560. In the case where the front insertion tube 560 is formed in a pair on the left and right with respect to the center of the cases 500 and 600, each of the pair of connection openings 561 formed in the pair of front insertion tubes 560 may be formed to face each of the front insertion tubes 560. In the case where a pair of front insertion tubes 560 are provided on the side of the cases 500 and 600, the connecting flow paths 920 extending from the connection openings 561 may extend toward the center of the cases 500 and 600, thereby enabling a compact configuration of the detergent pump 400.

When the rear insertion tube 620 is inserted into the front insertion tube 560 up to a point where the connection opening 561 is formed or beyond the point where the connection opening 561 is formed, the connection opening 561 may also be formed in the rear insertion tube 620 because the detergent moving through the rear insertion tube 620 is required to pass through the connection opening 561. In this case, the connection opening 561 formed in the front insertion tube 560 may be referred to as a first connection opening 562, and the connection opening 561 formed in the rear insertion tube 620 may be referred as a second connection opening 563. In other words, the connection opening 561 may include the first connection opening 562 and the second connection opening 563.

The connecting partition 570 may include a first partition 571 connected to one end of the connection opening 561 formed on one side of the front insertion tube 560, a second partition 572 connected to the other end of the connection opening 561 and formed to be spaced apart parallel to the first partition 571, and a partition connection 573 connecting the first partition 571 and the second partition 572 in a rounded manner.

The first partition 571, the second partition 572, and the partition connection 573 may protrude rearwardly at the same height. This may provide for a uniform width of at least some of the connecting flow paths 920 formed thereby.

A height at which the front insertion tube 560 protrudes rearwardly may be the same as a height at which the connecting partition 570 protrudes rearwardly. This may allow for a simple structure of the corresponding flow path sealing member 580 to be manufactured.

A spacing distance between the first partition 571 and the second partition 572 may be greater than the diameter of the front insertion tube 560. As will be described later, this may reduce the volume of the detergent discharge flow path through which the detergent is discharged. Reducing the volume of the detergent discharge flow path may help to reduce the frictional forces between the detergent and the surfaces of a member forming the detergent discharge flow path. As a result, the efficiency of the detergent pump 400 may be improved.

A groove may be formed on a front side of the flow path sealing member 580 to allow the rear edge of the front insertion tube 560 and the rear edge of the connecting partition 570 to be inserted.

The flow path sealing member 580 may include a material capable of being elastically deformed. Accordingly, the groove formed in the flow path sealing member 580 may prevent detergent from escaping between the front insertion tube 560 and the connecting partition 570 and the flow path sealing member 580.

The flow path sealing member 580 may extend outwardly with a certain thickness around the groove formed to form an exterior.

In other words, the flow path sealing member 580 may include a first flow path sealing member 581 formed in an annular shape to seal a rear side of the front insertion tube 560. The flow path sealing member 580 may include a second flow path sealing member 582 sealing the connecting partition 570 and extending from the first flow path sealing member 581. The second flow path sealing member 582 may have a width smaller than the diameter of the first flow path sealing member 581.

FIG. 7 is a cross-sectional perspective view illustrating the detergent pump 400 of FIG. 4 cut along AA′.

As shown in FIG. 7, detergent may be introduced into the detergent pump 400 through the intake space 521 formed inside the detergent intake portion 520. At this time, a detergent inlet 522 may be formed on a front lower side of the detergent intake portion 520.

The front insertion tube 560 may be formed on the rear side of the detergent intake portion 520. The rear insertion tube 620 may be inserted and coupled to the rear side of the front insertion tube 560.

A shared flow path 910 may be formed by the intake space 521 formed inside the detergent intake portion 520 and the front insertion tube 560 and the rear insertion tube 620. The shared flow path 910 may include the front shared flow path 911 formed by the front insertion tube 560 and the rear shared flow path 912 formed by the rear insertion tube 620.

A compression space 633 may be provided on a rear side of the shared flow path 910 and the compression space 633 may be connected to the shared flow path 910. The compression space 633 may be formed by the pumping portion 630 provided in the middle case 610.

The pumping portion 630 provided in the middle case 610 may include a cylinder 631 provided to form the compression space 633 and a piston 632 movably inserted into the cylinder 631 and capable of discharging the detergent accommodated in the compression space 633 therefrom.

In this case, the cylinder 631 may have a cylindrical shape. The piston 632 may also have a corresponding shape.

The cylinder 631 may be formed by extending up and down, and the piston 632 may move up and down within the cylinder 631 to vary the volume of the compression space 633. However, the present embodiment is merely an example, and the spirit of the present disclosure may be applied to an example in which the cylinder 631 may be formed by extending forward and backward, and the piston 632 may be formed by extending forward and backward.

However, when the cylinder 631 is formed by extending up and down, it may have less depth from front to back than when the cylinder 631 is formed by extending forward and backward. Given that the detergent supply apparatus 100 is formed inside the cabinet 10 (see FIG. 2), it is preferable for the detergent supply apparatus 100 not to elongate from front to back because parts for various functions may be install in the cabinet 10. However, as the cylinder 631 extends vertically, the length of the detergent supply apparatus 100 in a vertical direction may be extended. This is because the above-mentioned problem of arrangement with other parts may not arise since it is related to the height of the washing machine 1, and also the problem of arrangement with other parts may often be treated as more important than the problem of adjusting the height of the washing machine 1. It is therefore for the cylinder 631 to extend up and down rather than back and forth.

The piston 632 may have a conical shape with the center forming a vertex in a direction in which the piston 632 travels. A corresponding shape may be formed on a lower side of the cylinder 631. Accordingly, as the volume of the compression space 633 decreases, the detergent may be moved smoothly.

When the piston 632 is moved upward, the volume of the compression space 633 formed inside the cylinder 631 may increase. As a result, a negative pressure is created in the compression space 633. At this time, when the detergent intake portion 520 is positioned in the detergent receiving space 201 (see FIG. 3), and the detergent receiving space 201 contains at least a certain amount of detergent, the detergent may be introduced into the detergent pump 400 through the detergent inlet 522.

In this case, the first check valve module 591 may be disposed between the detergent intake portion 520 and the front shared flow path 911 to control the inflow and outflow of detergent. The first check valve module 591 may be provided with a head portion 594 tapered forwardly to be inserted into the intake space 521 formed in the detergent intake portion 520, and an elastic support portion 595 extending rearwardly from a rear side of the head portion 594. The elastic support portion 595 may be formed with a hollow extending back and forth at its center. This is because that the check valve body 593, which will be described later, is required to close the entrance to the intake space 521 to prevent detergent moving into the intake space 521. However, this process may cause the check valve body 593 to deform, and such a hollow may be formed to better facilitate the deformation of the check valve body 593.

In other words, the first check valve module 591 may include the check valve body 593 including the head portion 594 capable of opening or closing the intake space 521, and the elastic support portion 595 extending from one end of the head portion 594 and formed integrally with the head portion 594, the elastic support portion 595 having a cross-sectional area smaller than one end of the head portion 594.

The first check valve module 591 may include the elastic member 596 that elastically biases the check valve body 593 in a direction toward the intake space 521.

When the piston 632 moves upward, the check valve body 593 may move toward the compression space 633 due to the negative pressure generated in the compression space 633. Accordingly, the check valve body 593 may not block a space between the intake space 521 and the shared flow path 910.

The detergent introduced into the intake space 521 via the detergent inlet 522 may move into the shared flow path 910 connected to the intake space 521. The detergent moved to the shared flow path 910 may move to the compression space 633.

The flow path through which the detergent moves from the intake space 521 to the compression space 633 may be referred to as a detergent inflow path.

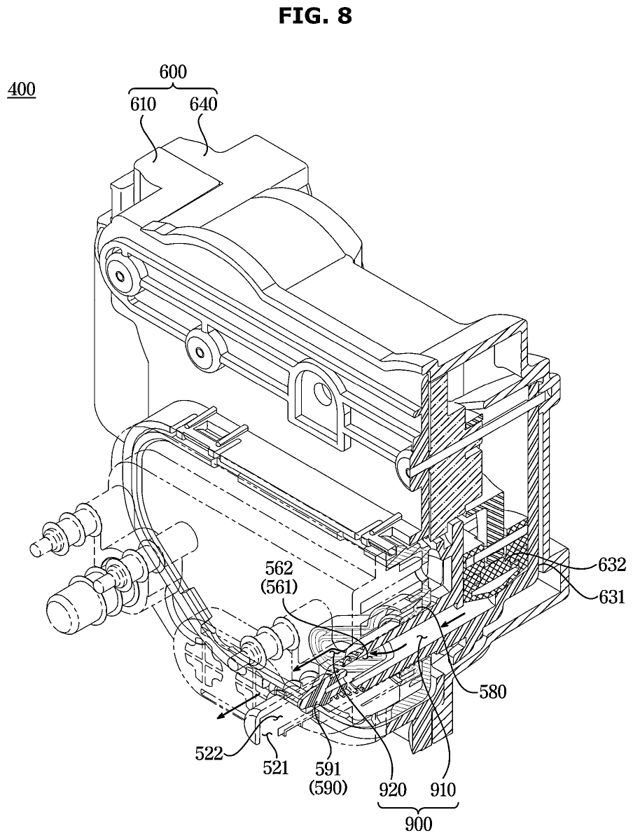

FIG. 8 is a cross-sectional perspective view illustrating a flow in which the detergent introduced into the detergent pump 400 of FIG. 7 is discharged.

As shown in FIG. 8, when the piston 632 is moved to the lower side of the cylinder 631, detergent may be moved to the outer side of the detergent pump 400.

When the piston 632 is moved to the lower side of the cylinder 631, the pressure of the detergent contained in the compression space 633 increases. Since the pressure of the detergent in the compression space 633 is higher than that of the outer side of the detergent pump 400, the detergent may be moved to the outer side of the detergent pump 400.

At this time, the check valve body 593 disposed between the intake space 521 and the shared flow path 910 may be moved to the intake space 521 side by the detergent leaving the compression space 633. Accordingly, the check valve body 593 may prevent the detergent from moving toward the intake space 521.

The detergent leaving the compression space 633 may be moved through the shared flow path 910. In other words, the shared flow path 910 may be the flow path through which the detergent moves when the detergent is introduced into the compression space 633, and the flow path through which the detergent moves when the detergent leaves the compression space 633.

As will be described later, in contrast to the present disclosure, it is possible that the detergent may not pass through the same flow path when detergent is introduced or discharged. In this case, it may be necessary for the detergent discharge portion 540 to extend in a different direction from the detergent intake portion 520. For example, when the detergent discharge portion 540 is formed to extend rearwardly, the detergent may need to be received within the mixing chamber 141 (see FIG. 15) formed within the housing 140 so that the detergent is mixed with the water flowing within the mixing chamber 141 and is moved toward the tub 20 (see FIG. 2). Accordingly, a flexible pipe connecting the housing 140 at the inlet of the detergent discharge portion 540 may also be further needed.

In addition to the need for an additional member connecting the detergent discharge portion 540 and the housing 140, if such a pipe is additionally included, the volume of the flow path through which the detergent moves may be increased. This is because the internal volume of the tube connecting the detergent discharge portion 540 and the housing 140 may also be included in the volume of a detergent outflow path.

Reducing the volume of the detergent outflow path may be an important consideration. Because detergent is viscous, as the detergent moves along the flow path, friction may be generated by the walls forming the flow path. Friction may mean loss. If force is generated to move the detergent, not all of the force may not be converted into energy to move the detergent. This is because such an energy may be lost due to friction between the detergent and the walls that form the flow path through which the detergent moves.

In particular, it is necessary to reduce the losses caused by the movement of the detergent from the time when the detergent is introduced into the detergent pump 400 and begins to receive a moving force to be discharged to the outside, until the time when the detergent is discharged.

Thus, assuming that the detergent pump 400 may include the pumping portion 630 forming the compression space 633 that may vary its volume so that the detergent positioned in the detergent receiving space 201 may be drawn into the inside of the detergent pump 400 or be discharged from the outside of the detergent pump 400, it is necessary to minimize the detergent outflow path through which the detergent moves from the compression space 633 to the outside of the detergent pump 400.

In theory, it is desirable to eliminate the detergent discharge flow path 900. In practice, to this end, this may be achieved by shaping the detergent discharge flow path 900 to have a small surface area.

More specifically, the detergent discharge flow path 900, which is connected to the compression space 633 inside the detergent pump 400 and is shaped to allow the detergent discharged from the compression space 633 to move to the outer side of the detergent pump 400, may be shaped such that its volume is less than or equal to the maximum volume of the compression space 633.

It is preferred that the piston 632 rises to the top of the cylinder 631 to form the maximum volume of the compression space 633 and that the piston 632 descends to the bottom of the cylinder 631 to form the minimum volume of the compression space 633. However, due to various design variables, the piston 632 may not rise to the top of the cylinder 631. In this case, the volume of the detergent discharge flow path 900 may be less than or equal to the maximum volume change of the compression space 633.

Assuming that the volume of the detergent discharge flow path 900 is the same as the volume of the compression space 633, when detergent is filled into the compression space 633 while no detergent is being filled into the detergent pump 400, and the piston is lowered once, the detergent discharge flow path 900 may be completely filled with detergent. This may allow the detergent pump 400 to quickly create an environment in which it may efficiently dispense detergent upon an initial operation.

Assuming that the volume of the detergent discharge flow path 900 is smaller than the volume of the compression space 633, when the piston 632 initially descends once, the detergent may be discharged to the outside of the detergent pump 400. This may create an environment in which the detergent pump 400 may dispense the detergent more quickly than in the case where the volume of the detergent discharge flow path 900 is equal to the volume of the compression space 633, as mentioned above.

The relationship between the detergent discharge flow path 900 and the compression space 633 is described above in terms of volume. The relationship between the detergent discharge flow path 900 and the compression space 633 may also be described in terms of cross-sectional area.

In other words, the area of a cross-section cut in a direction perpendicular to the direction in which the detergent discharge flow path 900 extends may be smaller than the area of a cross-section cut in a direction perpendicular to a direction in which the compression space 633 extends.

Alternatively, it may be described in terms of length. In other words, a distance between the two points at the farthest distance when any two points are selected on the edge of the cross-section cut in a direction perpendicular to the direction in which the detergent discharge flow path 900 extends may be smaller than the distance between the two points at the farthest distance when any two points are selected on the of the cross-section cut in a direction perpendicular to the direction in which the compression space 633 extends.

The detergent discharge flow path 900 may have a circular cross-section, and the cylinder 631 may also have a circular cross-section. In this case, the diameter of the detergent discharge flow path 900 may be smaller than or equal to the diameter of the compression space 633. However, in the drawings referred to herein, the cross-section of the detergent discharge flow path 900 is not shown to be circular along its entire length. However, the drawings of the present disclosure are shown only as an example and are not limited thereto.

However, in the present disclosure, the cross-sectional shape of the shared flow path 910 may also be circular. Accordingly, the diameter of the shared flow path 910 may be smaller than the diameter of the compression space 633.

In other words, the cross-sectional area of the shared flow path 910 may be smaller than the cross-sectional area of the compression space 633.

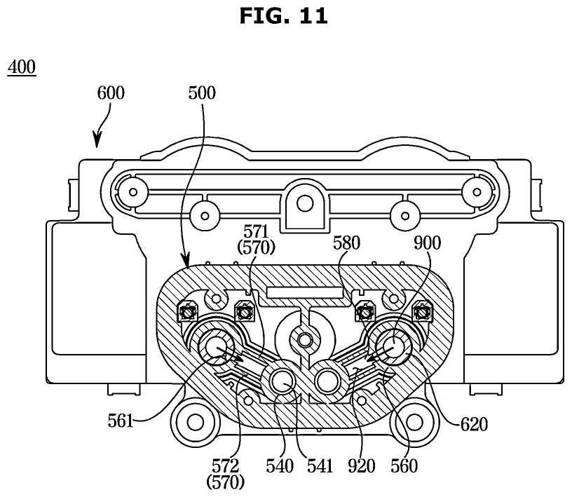

The detergent discharge flow path 900 may include the shared flow path 910 through which the detergent exiting the compression space 633 passes, the connecting flow path 920 connected to one side of the shared flow path 910, and the discharge space 541 connected to the connecting flow path 920 and formed on an inner side of the detergent discharge portion 540 (see FIG. 11).

Here, the shared flow path 910 may be referred to as the flow path connecting the intake space 521 and the compression space 633. The shared flow path 910 may be the flow path through which the detergent is moved when the detergent is moved from the intake space 521 to the compression space 633.

The connecting flow path 920 may be the flow path connecting the shared flow path 910 and the discharge space 541. The connecting flow path 920 may be the flow path through which the detergent moves through the shared flow path 910 when the detergent is moved from the compression space 633 to the discharge space 541.

However, as will be described later, the second check valve module 592 may be located between the discharge space 541 and the connecting flow path 920. The second check valve module 592 may regulate the outflow of the detergent located in the connecting flow path 920 into the discharge space 541, and thus the detergent discharge flow path 900 may be considered to include only the shared flow path 910 and the connecting flow path 920. A space including the shared flow path 910 and the connecting flow path 920 may be referred to as a detergent space.

In the following, the movement of the check valve module 590 and the detergent will be described again with reference to cross-sectional views.

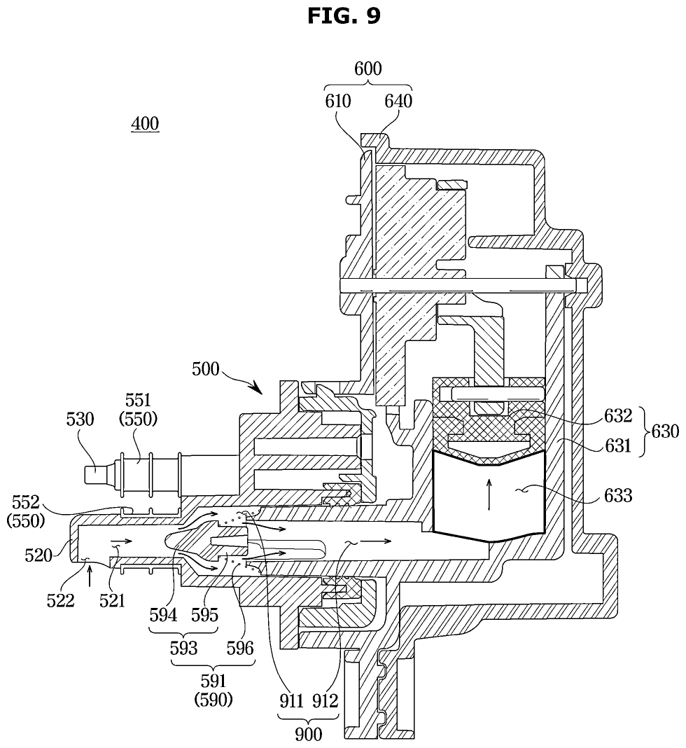

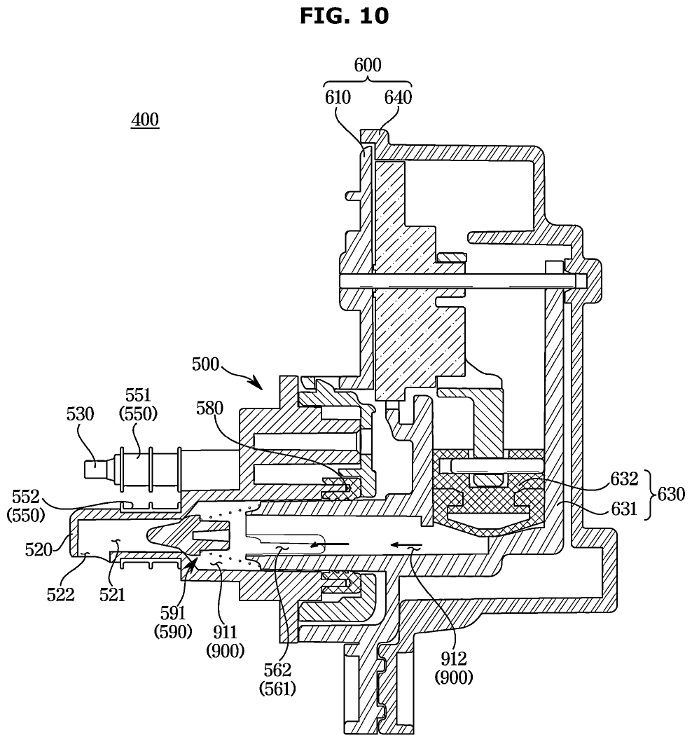

FIG. 9 is a cross-sectional view illustrating the detergent pump 400 of FIG. 4 cut along AA′. FIG. 10 is a cross-sectional view illustrating a flow of detergent introduced into the detergent pump 400 of FIG. 9 moving toward the connection opening.

As shown in FIGS. 9 and 10, the first check valve module 591 may move back and forth in response to the movement of the piston 632.

As shown in FIG. 9, when the piston 632 moves upward, the pressure in the compression space 633 becomes lower than the pressure in other spaces. As a result, an intake force may be created toward the compression space 633. In addition, the check valve body 593, which is normally elastically biased toward the intake space 521 by the elastic member 596, may move rearwardly. When the check valve body 593 moves rearwardly, the intake space 521 and the shared flow path 910 may communicate with each other.

The intake force toward the compression space 633 may intake not only the check valve body 593 but also detergent. The detergent may move into the intake space 521 formed within the detergent intake portion 520 and then move into the compression space 633 via the shared flow path 910.

Thereafter, as shown in FIG. 10, when the piston 632 moves downward, the pressure in the compression space 633 becomes higher than the pressure in other spaces. As a result, a force is generated to push the detergent out of the compression space 633. In addition, this may cause the check valve body 593, which has been moved rearward, to move forward again, thereby blocking the space between the intake space 521 and the shared flow path 910.

The detergent may move from the compression space 633 toward the connection opening 561 through the shared flow path 910. In particular, the connection opening 561 may be formed at a front end of the rear shared flow path 912. In the case where the connection opening 561 formed in the front insertion tube 560 is not formed at the forefront of the front insertion tube 560, the detergent passing through a portion, which is formed at a front side of the connection opening 561, of the front sharing flow path 911 formed on the inner side of the front insertion tube 560 may be reflected from the front side and move back towards the connection opening 561.

The detergent moving toward the connection opening 561 may move toward the connecting flow path 920. Hereinafter, the detergent moving toward the connecting flow path 920 will be described in detail.

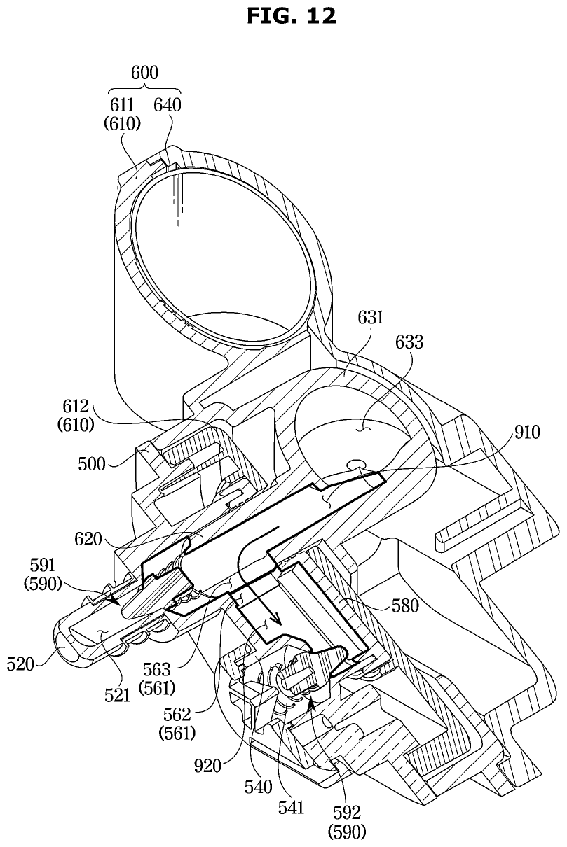

FIG. 11 is a cross-sectional view illustrating the detergent pump 400 of FIG. 4 cut along BB′. FIG. 12 is a perspective cross-sectional view illustrating the detergent pump 400 of FIG. 7 cut along CC′.

As shown in FIG. 11, detergent may move from the shared flow path 910 toward the connecting flow path 920. The connection opening 561 formed in the front insertion tube 560 and/or the rear insertion tube 620 may be arranged on one side of the shared flow path 910. The shared flow path 910 and the connecting flow path 920 may be formed by the connection opening 561.

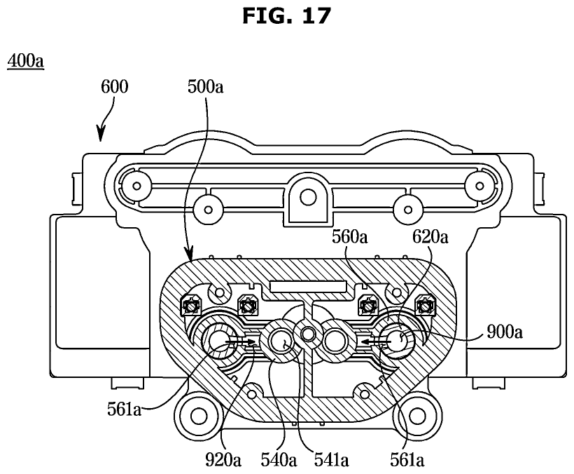

The connecting flow path 920 may extend toward the discharge space 541 formed by the detergent discharge portion 540. The connecting flow path 920 may extend with a downward slope toward a central portion of the housing 140. This is to utilize space by positioning the configuration compactly within the housing 140. However, the shape of the connecting flow path 920 is not limited thereto, and the ideas of the present disclosure may also be applied to the idea of the connecting flow path 920 having a horizontally extending shape, as shown in FIG. 17.

The end of the connecting flow path 920 may be connected to the discharge space 541 formed inside the detergent discharge portion 540 extending forward, so that the detergent discharge portion 540 may be is considered to be arranged on the lower side of the central portion of the housing 140.

As described above, the connecting flow path 920 may be formed by the connecting partition 570 and the flow path sealing member 580.

The detergent may move along the connecting flow path 920 to the lower center of the inner side of the housing 140.

As shown in FIG. 12, the detergent discharge portion 540 connected to the connecting flow path 920 may have a shape that protrudes toward a rear side of the connecting flow path 920. Accordingly, the connecting flow path 920 may be a flow path having different widths rather than a flow path having a single width.

The detergent may be discharged along the connecting flow path 920 into the discharge space 541 formed on the inside of the detergent discharge portion 540. This will be described in more detail below.

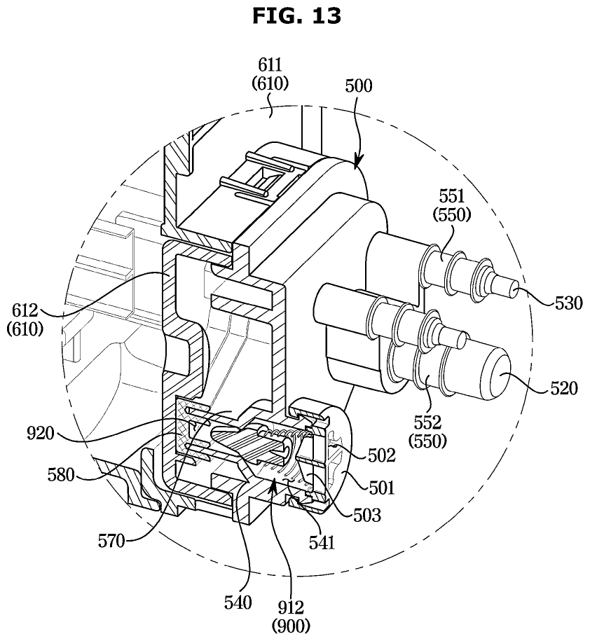

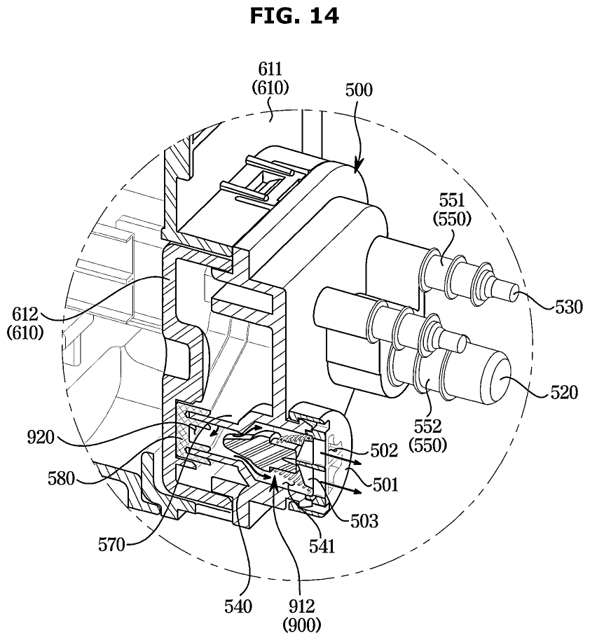

FIG. 13 is a perspective cross-sectional view illustrating the detergent pump 400 of FIG. 4 cut along DD′. FIG. 14 is a perspective cross-sectional view illustrating a flow in which the detergent introduced into the detergent pump 400 of FIG. 13 is discharged through the detergent discharge portion 540.

As shown in FIG. 13, the discharge of the detergent to the outside of the detergent discharge portion 540 may be regulated by the first check valve module 591 installed on the detergent discharge portion 540 side. The check valve body 593 may be elastically biased toward the connecting flow path 920 by the elastic member 596. The check valve body 593 may block an area where the connecting flow path 920 and the discharge space 541 are connected.

As shown in FIG. 14, when the piston 632 moves downward, the detergent may move to the inside of the connecting flow path 920, and thereby the check valve body 593 may move forward. Accordingly, the connecting flow path 920 and the discharge space 541 formed inside the detergent discharge portion 540 may be connected. This may cause the detergent to move toward the mixing chamber 141 (see FIG. 15).

FIG. 15 is a cutaway cross-sectional view illustrating the detergent supply apparatus 100 of FIG. 3.

As shown in FIG. 15, the detergent accommodated in the detergent receiving space 201 may be moved rearwardly to the inside of the detergent pump 400. The detergent that has moved to the inside of the detergent pump 400 may be moved to the mixing chamber 141 via the detergent discharge portion 540 through the above processes. Since the water flows toward the outlet 142 in the mixing chamber 141, the detergent moved to the mixing chamber 141 may be mixed with the water and moved toward the outlet 142. The moved detergent may be moved to the inside of the tub 20 through the outlet 142.

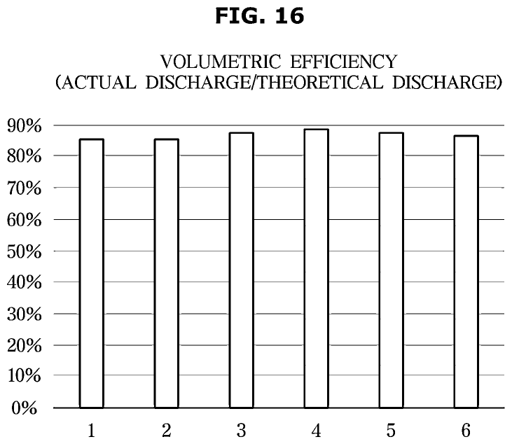

FIG. 16 is a graph summarizing the results of experiments in which different liquids were introduced into the detergent pump 400 of FIG. 4 and the outflow amounts were compared.

As shown in FIG. 16, experiments were conducted to determine the volumetric efficiency using different detergents.

A table summarizing the results of the experiments is given below.

TABLE 1

| | | | Theoretical |
|---|---|---|---|
| Object | Viscosity | Measurement item | Discharge (Max) |
| 1 | 0 | discharge per minute | 158 |
| | | discharge per second | 2.64 |
| 2 | 12 | discharge per minute | 158 |
| | | discharge per second | 2.64 |
| 3 | 180 | discharge per minute | 158 |
| | | discharge per second | 2.64 |
| 4 | 448 | discharge per minute | 158 |
| | | discharge per second | 2.64 |
| 5 | 496 | discharge per minute | 158 |
| | | discharge per second | 2.64 |
| 6 | 2980 | discharge per minute | 158 |
| | | discharge per second | 2.64 |

TABLE 2

| Object | Measurement item | 1st | 2nd | 3rd |
|---|---|---|---|---|
| 1 | discharge per minute | 128 | 135 | 140 |
| | discharge per second | 2.13 | 2.25 | 2.33 |
| 2 | discharge per minute | 134 | 138 | 138 |
| | discharge per second | 2.23 | 2.30 | 2.30 |
| 3 | discharge per minute | 134 | 142 | 142 |
| | discharge per second | 2.23 | 2.37 | 2.37 |
| 4 | discharge per minute | 140 | 142 | 145 |
| | discharge per second | 2.33 | 2.37 | 2.42 |
| 5 | discharge per minute | 134 | 140 | 141 |
| | discharge per second | 2.23 | 2.33 | 2.35 |
| 6 | discharge per minute | 136 | 137 | 138 |
| | discharge per second | 2.27 | 2.28 | 2.30 |

TABLE 3

| Object | Measurement item | 1st | 2nd | 3rd |
|---|---|---|---|---|
| 1 | discharge per minute | 130 | 136 | 138 |
| | discharge per second | 2.17 | 2.27 | 2.30 |
| 2 | discharge per minute | 130 | 133 | 134 |
| | discharge per second | 2.17 | 2.22 | 2.23 |
| 3 | discharge per minute | 136 | 141 | 142 |
| | discharge per second | 2.27 | 2.35 | 2.37 |
| 4 | discharge per minute | 137 | 139 | 139 |
| | discharge per second | 2.28 | 2.32 | 2.32 |
| 5 | discharge per minute | 137 | 140 | 142 |
| | discharge per second | 2.28 | 2.33 | 2.37 |
| 6 | discharge per minute | 132 | 139 | 139 |
| | discharge per second | 2.20 | 2.32 | 2.32 |

TABLE 4

| Object | Measurement item | 1st | 2nd | 3rd |
|---|---|---|---|---|
| 1 | discharge per minute | 132 | 140 | 138 |
| | discharge per second | 2.20 | 2.33 | 2.30 |
| 2 | discharge per minute | 136 | 139 | 141 |
| | discharge per second | 2.27 | 2.32 | 2.35 |
| 3 | discharge per minute | 135 | 141 | 141 |
| | discharge per second | 2.25 | 2.35 | 2.35 |
| 4 | discharge per minute | 137 | 144 | 143 |
| | discharge per second | 2.28 | 2.40 | 2.38 |
| 5 | discharge per minute | 135 | 140 | 141 |
| | discharge per second | 2.25 | 2.33 | 2.35 |
| 6 | discharge per minute | 134 | 139 | 139 |
| | discharge per second | 2.23 | 2.32 | 2.32 |

TABLE 5

| Object | Measurement item | 1st | 2nd | 3rd |
|---|---|---|---|---|
| 1 | discharge per minute | 135 | 139 | 140 |
| | discharge per second | 2.25 | 2.32 | 2.33 |
| 2 | discharge per minute | 134 | 140 | 139 |
| | discharge per second | 2.23 | 2.33 | 2.32 |
| 3 | discharge per minute | 136 | 140 | 141 |
| | discharge per second | 2.27 | 2.33 | 2.35 |
| 4 | discharge per minute | 138 | 141 | 141 |
| | discharge per second | 2.30 | 2.35 | 2.35 |
| 5 | discharge per minute | 137 | 141 | 141 |
| | discharge per second | 2.28 | 2.35 | 2.35 |
| 6 | discharge per minute | 133 | 138 | 140 |
| | discharge per second | 2.22 | 2.30 | 2.33 |

TABLE 6

| Object | Measurement item | 1st | 2nd | 3rd |
|---|---|---|---|---|
| 1 | discharge per minute | 134 | 140 | 140 |
| | discharge per second | 2.23 | 2.33 | 2.33 |
| 2 | discharge per minute | 135 | 139 | 140 |
| | discharge per second | 2.25 | 2.32 | 2.33 |
| 3 | discharge per minute | 135 | 140 | 140 |
| | discharge per second | 2.25 | 2.33 | 2.33 |
| 4 | discharge per minute | 139 | 140 | 141 |
| | discharge per second | 2.32 | 2.33 | 2.35 |
| 5 | discharge per minute | 136 | 140 | 141 |
| | discharge per second | 2.27 | 2.33 | 2.35 |
| 6 | discharge per minute | 135 | 140 | 140 |
| | discharge per second | 2.25 | 2.33 | 2.33 |

TABLE 7

| | | | Volumetric |
|---|---|---|---|
| Object | Measurement item | Average | efficiency |
| 1 | discharge per minute | 136.3333 | |
| | discharge per second | 2.272222 | 86% |
| 2 | discharge per minute | 136.6667 | |
| | discharge per second | 2.277778 | 86% |
| 3 | discharge per minute | 139.0667 | |
| | discharge per second | 2.317778 | 88% |
| 4 | discharge per minute | 140.4 | |
| | discharge per second | 2.34 | 89% |
| 5 | discharge per minute | 139.0667 | |
| | discharge per second | 2.317778 | 88% |
| 6 | discharge per minute | 137.2667 | |
| | discharge per second | 2.287778 | 87% |

As shown in Table 1, detergents of different viscosities were added to the detergent pump module used in the experiment, and the amount of detergent discharged were measured. Theoretically, the amount of detergent that should be discharged may be the volume change of the compression space 633.

Tables 2 to 6 show the amounts of detergent added during the experiments. Three experiments were carried out for each round of experiments, and the experimental values for each round are shown in each table. Since the amount of detergent added is the amount of detergent discharged, the value of the amount of detergent added may be a value of the amount of the detergent discharged.

Table 7 summarizes the results.

In the experiments with detergent, the comparison of the experimental discharge with the theoretical discharge shows an overall volumetric efficiency of approximately 87%. The volumetric efficiency may be a comparison of the amount of detergent due to the volume change in the compression space 633 and the amount of detergent actually discharged out of the detergent pump.

Given that object 1 is water, it can be seen that viscous detergents may have a similar volumetric efficiency to water. This shows that the volumetric efficiency is improved by applying the ideas of the present disclosure.

Furthermore, it can be seen that detergents of different viscosities generally have similar volumetric efficiencies. This means that in the case of the detergent pump according to the present disclosure, the variation in energy loss of the detergent due to viscosity is minimized.

FIG. 17 is a cross-sectional view illustrating a detergent pump 400a according to an embodiment of the present disclosure.

As shown in FIG. 17, a connecting flow path 920a may be formed horizontally.

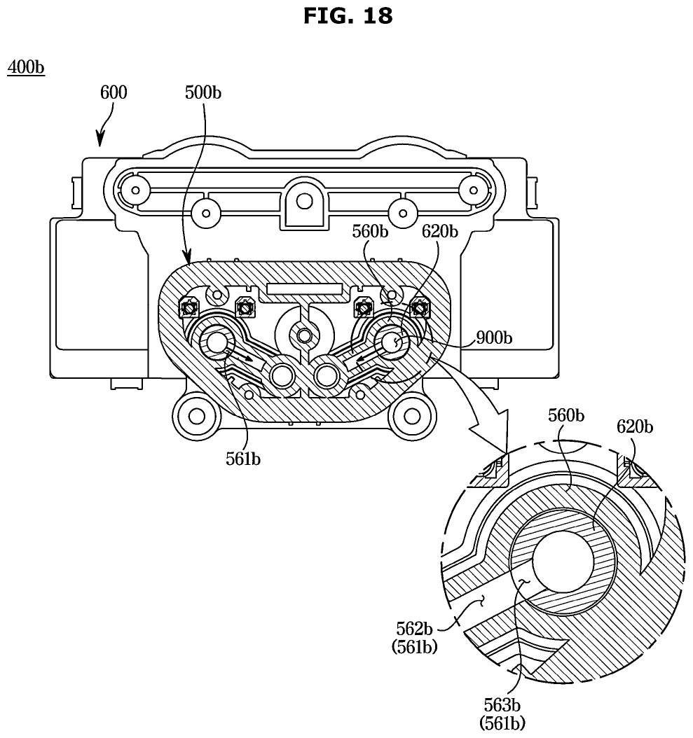

FIG. 18 is a cross-sectional view illustrating a detergent pump 400b according to an embodiment of the present disclosure.

As shown in FIG. 18, a connection opening 561b, which is a portion where a shared flow path 910b and a connecting flow path 920b are connected, may be formed without a stepped portion. This may reduce the generation of vortices.

While the present disclosure has been particularly described with reference to exemplary embodiments, it should be understood by those of skilled in the art that various changes in form and details may be made without departing from the spirit and scope of the present disclosure.

What is claimed is:

1. A washing machine, comprising:
a cabinet;
a drum arrangeable on an inner side of the cabinet such that while the drum is arranged on the inner side of the cabinet, the drum forms a laundry room; and
a detergent supply apparatus configured to supply detergent to the laundry room, the detergent supply apparatus including:
a detergent container forming a detergent receiving space to accommodate the detergent to be supplied to the laundry room, and
a detergent pump, coupleable to and decouplable from the detergent container, configured to pump detergent accommodated in the detergent receiving space toward the laundry room; the detergent pump including:
a pumping portion including a compression space having a volume that is controllable to be varied such that the detergent accommodated in the detergent receiving space is drawn into an inner side of the detergent pump or is discharged to an outer side of the detergent pump as the volume of the compression space is varied,
a detergent discharge flow path connectable to the compression space such that while the detergent discharge flow path is connected to the compression space, detergent discharged from the compression space is moved to the outer side of the detergent pump, and
wherein a volume of the detergent discharge flow path is less than or equal to a maximum volume of the compression space.

2. The washing machine of claim 1, wherein the volume of the detergent discharge flow path is less than or equal to a maximum volume change of the compression space.

3. The washing machine of claim 1, wherein the pumping portion comprises:
a cylinder configured to form the compression space, and
a piston moveable to be inserted into the cylinder and enabled to discharge the detergent accommodated in the compression space from the compression space, and
wherein a cross-sectional area of the detergent discharge flow path is smaller than the cross-sectional area of the compression space.

4. The washing machine of claim 1, wherein the detergent pump comprises:
a first check valve module configured to open or close the detergent discharge flow path by the pumping portion on a side where detergent moves inward, and
a second check valve module configured to open or close the detergent discharge flow path by the pumping portion on a side where the detergent moves outward,
wherein the detergent discharge flow path is a detergent space disposed between the first check valve module and the second check valve module, and a volume of the detergent space is equal to or smaller than the volume of the compression space.

5. The washing machine of claim 1, wherein
the detergent pump includes a front case and a rear case coupleable to a rear side of the front case, and
the front case comprises:
a front case body,
a detergent intake portion extending from the front case body in a direction in which the detergent pump is coupleable with the detergent container, the detergent intake portion forming an intake space therein, and
a detergent discharge portion extending forwardly from the front case body and forming a discharge space therein.

6. The washing machine of claim 5, further comprising:
a shared flow path, connecting the intake space and the compression space, and configured to allow detergent to be movable based on the detergent being moved from the intake space to an inner side of the compression space, and
a connecting flow path, connecting the shared flow path and the discharge space, and configured to allow detergent to be movable through the shared flow path based on the detergent being moved from the compression space to the discharge space.

7. The washing machine of claim 6, wherein
the front case includes a front insertion tube extending rearwardly of the detergent intake portion and forming a front shared flow path connected to the intake space, and
the rear case includes a rear insertion tube extending forwardly to be inserted into the front insertion tube and forming a rear shared flow path connected to the compression space.

8. The washing machine of claim 6, wherein a cross-sectional area of the shared flow path is smaller than the cross-sectional area of the compression space.

9. The washing machine of claim 6, wherein a diameter of the shared flow path is smaller than a diameter of the compression space.

10. The washing machine of claim 7, wherein
the front case includes a connecting partition connected to the front insertion tube and extending to form the connecting flow path, and
the detergent pump includes a flow path sealing member configured to form the connecting flow path by sealing a rear side of the front insertion tube and the connecting partition.

11. The washing machine of claim 10, wherein the connecting partition comprises:
a first partition connected to one side of a connection opening formed on one side of the front insertion tube,
a second partition connected to another side of the connection opening and formed to be spaced apart parallel to the first partition, and
a partition connection connecting the first partition and the second partition in a rounded manner.

12. The washing machine of claim 11, wherein a spacing distance between the first partition and the second partition is smaller than a diameter of the front insertion tube.

13. The washing machine of claim 11, wherein the flow path sealing member comprises:
a first flow path sealing member formed in an annular shape to seal the rear side of the front insertion tube, and
a second flow path sealing member sealing the connecting partition and having a width smaller than a diameter of the first flow path sealing member.

14. The washing machine of claim 4, wherein the first check valve module comprises:
a check valve body including a head portion enabled to open or close an intake space, and an elastic support portion extending from one end of the head portion and formed integrally with the head portion, the elastic support portion having a cross-sectional area smaller than the one end of the head portion, and
an elastic member configured to elastically bias the check valve body in a direction toward the intake space.

15. The washing machine of claim 3, wherein
the cylinder is formed to extend vertically, and
the piston moves up and down within the cylinder to vary the volume of the compression space.
